(19) United States
(12) Patent Application Publication
(10) Pub. No.: US 2008/0212864 A1
(43) Pub. Date: Sep. 4, 2008

(54) Method and Arrangement Relating to X-Ray Imaging

(75) Inventor: Hans Bornefalk, Stockholm (SE)

Correspondence Address: SYNNESTVEDT LECHNER & WOODBRIDGE LLP, P O BOX 592, 112 NASSAU STREET, PRINCETON, NJ, 08542-0592, US

(73) Assignee: SECTRA MAMEA AB, Kista (SE)

(21) Appl. No.: 10/597,928

(22) PCT Filed: Feb. 14, 2005
(86) PCT No.: PCT/SE2005/000195

§ 371 Date: Apr. 7, 2008

(30) Foreign Application Priority Data
Feb. 13, 2004 (SE) 0400325-7

(51) Int. Cl. G06K 9/00

(52) U.S. Cl. 382/132

(57) ABSTRACT

The present invention relates to a method and arrangement for detecting a Region of Interest in an image data set, especially digitalized X-ray image. The method comprises the steps of: extracting phase information from the image data, using said phase information for differentiating between different lines and edges, and skewing said lines towards a centre.

### FIELD OF INVENTION

The present invention relates to the detection of specific characteristics in an X-ray image, and more especially malignant tumors in digitally produced mammograms, and in particular to a method of finding stellate lesions based on phase information obtained from for instance quadrature filters.

### BACKGROUND OF INVENTION

Breast cancer is a serious health threat and effects many women each year. At the present, there is no existing means for preventing breast cancer; however methods have been developed for screening women for early detection of cancer. Mammography using x-rays is currently the most used method and is used for screening large populations of people. It is of importance to diagnose patients at as an early stage as possible, which means that the malignant lesions are small and hard to detect.

The large quantity of people to screen means that a large amount of images has to be screened and a physician or radiologist may be required to examine several hundreds of mammograms per day. This increases the risk of a missed diagnosis due to human error especially as the lesions may be small and hard to detect.

Accordingly, Computer Aided Diagnosis (CAD) systems for screening of medical digital images have been developed for assisting in the detection of abnormal lesions, for instance spiculations. Malignant lesions can often be revealed by looking for spiculations, i.e. stellar-shaped lesions. These may be visible in mammograms and come in many different sizes. The presence of stellate-like spicules radiating from a center mass is a highly suspicious indicator of malignancy. Many methods and systems have therefore been developed for the detection of such features in x-ray images.

Karssemeijer et al (N. Karssemeijer et al, “Detection of Stellate Distortions in Mammograms”, IEEE transactions on Medical Imaging, Vol 15, No 5, pp 611-619, 1996) suggested a statistical method based on a map of pixel orientations. Another method is based on first identifying individual spicules and then via a Hough transform, accumulates evidence that they point in a certain direction. This method is used for instance by Kobatake et al (H. Kobatake et a/, “Detection of Spicules on Mammogram Based on Skeleton Analysis”, IEEE Transactions on Medical Imaging, Vol. 15, No 3, pp 235-245) and Ng et al (S. L. Ng et al, “Automated detection and classification of breast tumors”, Computers and Biological Res., Vol. 25, pp 218-237, 1992.

A third method is based on histogram analysis of gradient angles as proposed in Kegelmeyer (W. P. Kegelmeijer Jr., “Computer Detection of Stellate Lesions in Mammograms”, Proc. SPIE Conf. Biomedical Image Processing and Three-Dimensional Microscopy, Vol 1660, 1992). The basic idea is that if the standard deviation of gradient angles in a certain local neighborhood or area is high, then it is an indication that the gradients point in all-different directions. This would indicate a stellate pattern. This is also outlined in U.S. Pat. No. 5,633,958, wherein a method and apparatus for detecting a desired behavior in digital image data is presented. In this system stellate lesions are detected in digitized mammography image data using an ALOE (analysis of local oriented edges) approach is implemented to calculate features. The primary disadvantage of using the ALOE algorithm is that many unwanted background objects can produce signals false signals indicative of malignant lesions. Also because every direction may not be present in the histogram of gradient angles, the standard deviation of the histogram may still be quite large resulting in a larger ALOE signal and spiculations may thus be missed. Thus the ALOE algorithm produces false positives and also results in missed speculations.

A common problem when detecting spiculated lesions is that they range in size from a few millimeters up to several centimeters. This may be problematic for some lesion detection methods. One way of addressing this problem is to use the detection system on several different scales. Karssemejer et al uses this kind of approach to overcome this problem.

Another solution for finding lesions in images is based on an artificial neural network that compares found features in an unknown image with features found in images with known diagnoses and this solution is presented in US patent application number 2001/0043729. Since this is based on the availability of images of known diagnoses it will only find similar looking lesions.

Yet another solution is presented in U.S. Pat. No. 6,263,092, wherein a method and apparatus for fast detection of spiculated lesions using line and direction information found in the image and accumulating regions of possible intersections to produce a cumulative array. Information derived from the cumulative array is used for identifying spiculations in the digital mammogram image. One problem with this method is that both stellar and circle shaped features will result in the similar histograms and thus the method will produce false positive signals increasing the burden on the radiologist/physician that manually interpret and examine the images before diagnosing.

### SUMMARY OF INVENTION

The present invention proposes a novel method and apparatus for detecting interesting characteristics in an x-ray image, and more especially malignant lesions or suspicious features in digital medical images and in particular proposes a new method for finding the Region of Interest (ROI) in a CAD (Computer Aided Diagnosis) system that has many optimization possibilities and yet is fast and accurate and still overcomes some of the above mentioned problems.

For these reasons, a method for detection of stellate lesions in a digitalized mammogram is provided. The method comprises the steps of: obtaining an image data corresponding to the mammogram; obtaining an image mask; substantially uniformly sampling the digital image inside the mask and producing sample points; calculating for each sample point a characteristic; selecting a number of sampling points most likely to correspond to a spiculated lesion; applying a segmentation procedure to the original digital image at the selected sampling points; extracting new characteristics from each segmented area and obtaining a feature vector; classifying each feature vector as suspicious or non-suspicious using a classification machine; and examining the suspicious areas. The characteristics comprise one or several of: contrast, two measures of spiculatedness, and two measures of edge orientations. The contrast is derived as a ratio between intensity inside a circle with a radius r1 and a washer shaped background area with inner radius r1 and an outer radius r2. The two measures of spiculatedness are derived from a histogram of angle differences obtained using a filtration method that yields phase information together with orientation estimates. The two measures of edge orientations are derived from a histogram of angle differences obtained using a filtration method that yields phase information together with orientation estimates.

Extracting can be done using a support vector machine or an artificial neural network. The classification of each feature vector can be done using a classification machine. Preferably, the entire image is sampled. Each node in the applied sampling grid is evaluated in terms of contrast and spiculation.

The invention also relates to a method of detecting a Region of Interest in a digitalized X-ray image, comprising the steps of: extracting phase information from the image, using the phase information for differentiating between different lines and edges, and skewing the lines towards a centre. The first step comprises extracting an orientation estimate. The second step comprises additional information on a magnitude from a filter answer.

The invention also relates to an arrangement for detecting a Region of Interest in a digitalized X-ray image. The arrangement comprises: a processing unit, a module for obtaining image masks, a sampling module, a calculating module, filtration module, a classification module and a support vector machine and/or artificial neural network module. The filtration module is a set of quadrature-filter. The invention also relates to n x-ray apparatus comprising an above-mentioned arrangement.

The invention also relates to a computer unit comprising a processing unit, a memory unit, storage unit, the computer unit being operatively arranged with an instruction set to acquire a digitalized x-ray image. The instruction set has procedures for: detecting a Region of Interest in a digitalized X-ray image, extracting phase information from the image, obtaining image masks, sampling, calculating, filtration, a classification and supporting vector and/or artificial neural network.

The invention may be realized as a computer program for detection of stellate lesions in a digitalized mammogram. The program comprises: an instruction set for obtaining an image data corresponding to the mammogram; an instruction set for obtaining an image mask; an instruction set for substantially uniformly sampling the digital image inside the mask and producing sample points; a calculation procedure for each sample point a characteristic; an instruction set for selecting a number of sampling points most likely to correspond to a spiculated lesion; an instruction set for applying a segmentation procedure to the original digital image at the selected sampling points; an instruction set for extracting new characteristics from each segmented area and obtaining a feature vector; and classifying procedure for classifying each feature vector as suspicious or non-suspicious using a classification machine.

### BRIEF DESCRIPTION OF DRAWINGS

The present invention will become more fully understood from the detailed description given below together with the accompanying drawings, which are given for illustrative purposes only and should not be considered limiting the present invention and wherein:

FIG. 1 illustrates an X-ray apparatus employing an arrangement according to the present invention.

FIGS. 2 A and B illustrates an image area with a malignant lesion and a corresponding line image of the same area respectively.

FIGS. 3 A and B illustrates an image area with a malignant lesion and a corresponding edge image of the same area respectively.

FIGS. 4 A and B shows histograms of angle difference distributions from line and edge analysis respectively.

FIGS. 5 A and B shows original mammogram and SVM output from a ROI extraction step respectively. A stellate lesion is marked in both images with an arrow (A and B).

FIG. 6 A shows a local neighborhood of a malignant stellate lesion and B shows the output from a level set segmentation algorithm for the same local neighborhood.

FIGS. 7 A and B shows an original grid output and SVM output after segmentation respectively.

FIG. 8 shows block diagram of an arrangement implementing the stellate lesion detection method of the present invention.

FIG. 9 is flow diagram illustrating the main steps of the invention.

FIG. 10 is distribution of the angle differences corresponding to the pixels.

### DETAILED DESCRIPTION OF INVENTION

The present invention proposes a novel method for detecting Region of Interests with special characteristics generally and particular stellate lesions in digitized x-rays images, especially mammogram images, in the scope of computer-aided diagnosis (CAD). The method/system is used as an aid to radiologists or physicians in the characterization and classification of mass lesions in mammography. Studies have shown that such a system can aid in increasing the diagnostic accuracy and increase the examination rate. According to the most general implementation, the invention comprises detecting a Region of Interest in a digitalized X-ray image by: extracting phase information from the image, using the phase information for differentiating between different lines and edges, and skewing the lines towards a centre. The extraction step comprises extracting a orientation estimate. The phase information comprises additional information on a magnitude from a filter answer.

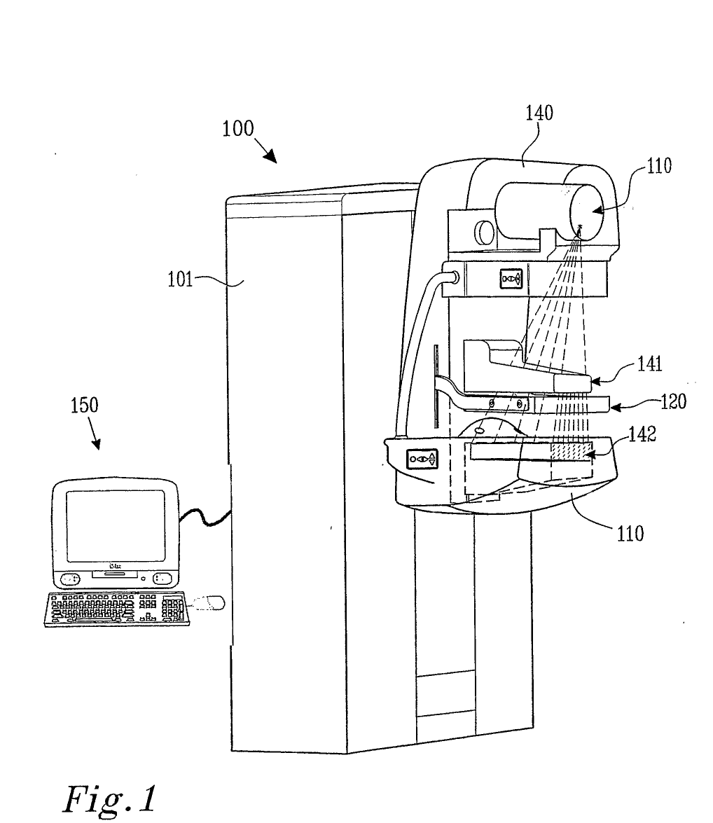

An exemplary X-ray apparatus is illustrated in a schematic way in FIG. 1. The apparatus 100 comprises an x-ray source 110, a collimator 120 and a detector assembly 130 arranged in a housing 140 and supported by a supporting structure 101. The housing further comprises an upper plate 141 housing the collimator 120 and a lower plate 142 housing the detector assembly 130. An object to be examined, e.g. a breast, is positioned between the upper and lower plates and compressed before exposure to the X-rays. In this case a computer 150 is connected to the X-ray apparatus for processing the information received from the detector assembly, e.g. execute CAD.

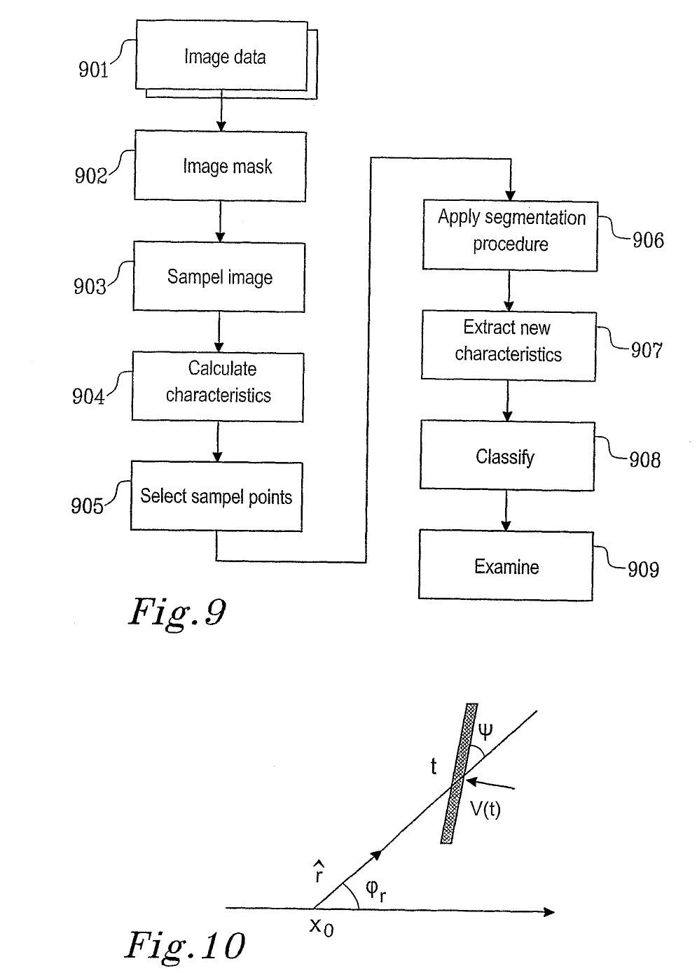

A CAD method according to the present invention includes several steps with different purposes and these will be presented in conjunction with FIG. 9 in an order as they appear in the process.

The first step involves obtaining a digital image 901 from a mammography measurement, e.g. the aforementioned apparatus 100. The image may be obtained directly from the X-ray apparatus, scanning a film obtained during a mammography measurement (film based mammography apparatus), or collecting an image from a database of stored images located either locally at a mammography facility or externally at some central database. For instance for test, training, and evaluation purposes, images may be obtained from the Digital Database for Screening Mammography at the University of South Florida, etc.

In some cases the images need some image pre-processing, for instance noise reduction or thickness equalization, before starting the actual detection algorithm.

Preferably, the image is subjected 902 to a mask according to standard tools in the field.

The mammogram is subjected to a grid pattern in order to uniformly sample 903 the image inside the mask. This is done by applying the grid with a distance d between nodes in x and y directions.

For each sampling point obtained above, several features are calculated 904:
i) The contrast of the image is calculated by calculating the ratio between the average intensity inside a circle with radius r1 and a washer shaped background area with inner radius r1 and outer radius r2,
ii) Two measures of so called spiculatedness is derived from a histogram of angle differences which will be discussed in more detail below, and
iii) Two measures of edge orientations are derived from the histogram of angle differences.

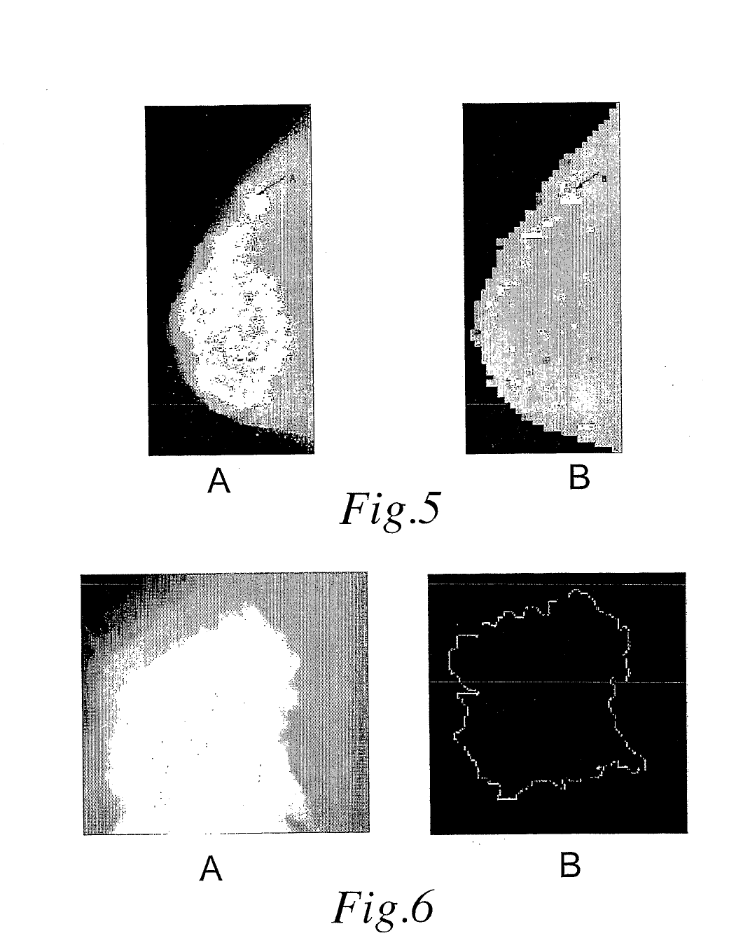

A support vector machine or any other learning machine such as an artificial neural network may be used to select 905 a number of sampling points that are most likely to correspond to malignant tissue, in particular spiculated lesions. A segmentation algorithm is applied 906 to the original mammogram at coordinates corresponding to the current sampling point as is illustrated in FIG. 6 in order to prevent sampling points close to each other from being extracted and to use the segmented area to extract refined features.

New features are extracted from each segmented area, including, but not limited to, contrast between the segmented Region of Interest (ROI) and its immediate background, spiculation and edge measures calculated using the same method as above, texture features are calculated according standard tools in the technical field, shape features are also calculated using standard tools, and intensity based features are calculated using standard tools of the trade.

Each feature vector is passed on to a classifying machine to be classified into either suspicious or non-suspicious features. A user-defined threshold may be implemented in order to determine the trade off between false positive findings and false negative findings.

Suspicious areas are marked for later examination by a radiologist or physician.

In the following, above described steps are detailed.

In order to find regions of interest (ROIs) different methods for finding seed points exist. Most methods are intensity based using the fact that many tumors have a well-defined central body, whereas other methods search for spiculation features and try to determine from where the spicules emanate from. The present invention uses a combination of these two methods and adds another method to capture the edge orientation. The entire image is sampled in order to minimize the risk of missing any areas of interest and each node in the applied sampling grid is evaluated in terms of contrast and spiculation.

As mentioned before, the features vary in size and therefore this evaluation is done on three different scales.

The contrast measured at node i, j is defined as the contrast between a circular area with radius r1 centered at i, j and a washer shaped area with inner radius r1 and outer radius r2. r1 and r2 can be any size but may for instance be r and 2π.

The spiculation and edge measures are based on orientation estimates extracted from a filtration method that can extract phase information together with orientation estimates. One such filtration method may be for instance by using a quadrature filter set, e.g. four filters.

An example employing a quadrature filter is disclosed in the following:

Quadrature filters and a method to construct orientation tensors from the quadrature filter are described in G. H. Granlund, H. Knutsson, “Signal Processing for Computer Vision”, Kluwer Academic Publishers, Dordrecht, 1995. The directing vector of quadrature filter i is denoted \hat{n}ᵢ with φᵢ=arg(\hat{n}ᵢ). The quadrature filter is complex and hence the output qᵢ from convolution of the filter and the image signal will be complex. Let qᵢ denote the magnitude and qᵢ and similar for the phase angle θᵢ=arg(qᵢ).

The local orientation in an image is the direction in which the signal exhibits maximal variation. With 0=(i−1)*n/4, the 2D orientation vector may be expressed conveniently as

z=(q₁−q₃,q₂−q₄).

Thus, if v is a vector oriented along the axis of maximal signal orientation, the following relationship hold between the arguments of z and v: arg(z)=2*arg(v).

The phase angle introduced above reflects the relationship between the evenness and oddness of the signal. In the spatial domain, a quadrature filter may be written as a sum of a real line detector and a real edge detector:

f(x)=fₗᵢₙₑ(x)−if_{edge}(x).

fₗᵢₙₑ is an even function and f_{edge} is an odd function and this can be used to distinguish between lines and edges. Extending the phase concept to two dimensions is not trivial, but will give the necessary means to distinguish different features from each other, namely edges, bright lines, and dark lines. The reason for the difficulties is that the phase can not be defined independently of directions, and as the directing vectors of the quadrature filters point in different directions, and thus yield opposite signs for similar events, care must be taken in the summation. A method for weighting the filter output is the following: let [symbol] (qᵢ) and ℑ(qᵢ) denote the real and imaginary parts of the filter output from the quadrature filter in direction \hat{n}ᵢ. The weighted filter output is then given by

$$( q ) = {\sum }_{i = 1}^{4} ( {q}_{i} )$$

$$( q ) = {\sum }_{i = 1}^{4} sign ( cos ( {ϕ}_{i} - ϕ ) ) ( {q}_{i} )$$

The interpretation of the cosine factor is that when the local orientation in the image and the directing vector of the filter differ by more than π/2 the filter output must be conjugated to account for the anti-symmetric imaginary part. The total phase θ is now given as θ=arg(q)=arg( [symbol] (q)+iℑ(q)). Phase angles close to zero correspond to bright lines, phase angles close to i+correspond to dark lines and phase angles close to ±π/2 correspond to edges.

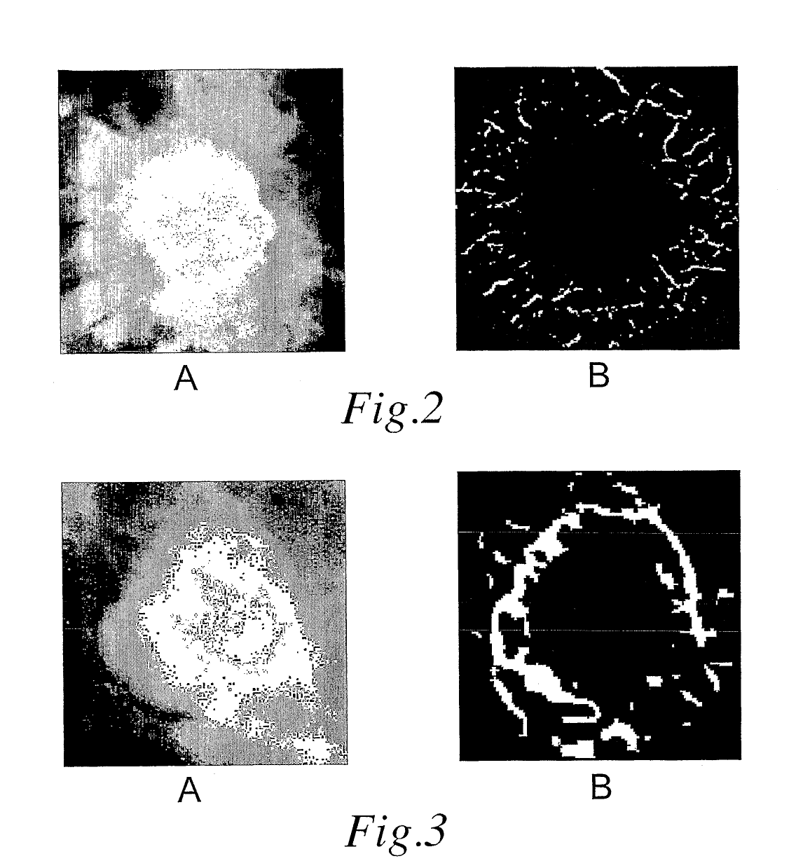

By thresholding the filter outputs on certainty and phase, a line image is produced. This may be used to separate bright lines and thus candidates for spicules, from the surrounding tissue. Such a test is shown in FIG. 2, where the real image is shown on the left 1A and the calculated image is shown to the right 1B using a particular phase angle threshold.

Using another phase angle threshold an edge image is produced as may be seen in FIG. 3, wherein 3A is the real image and 3B is the calculated image.

There is a clear difference in these two images 2B and 3B. The question now comes up on how to quantify this difference. This is achieved by constructing a measure of spiculatedness in a local area or neighborhood. The direction of maximal signal variation in a pixel on a detected bright line is v(x) and let φ=arg(v(x)). Then we get the following expression for the double angle representation of local orientation:

z(x)=c(x)e^{i2φ}=q₁−q₃+i(q₂−q₄).

Let \hat{r} denote a normalized vector pointing from a coordinate x₀ in the image to another pixel x. Since the vector \hat{r} is normalized it may be expressed as (cos φᵣ(x),sin φᵣ(x)). Let us now define

\hat{r}_{double}(x)=(cos(2φᵣ),sin(2φᵣ)).

If x is located on a line radiating away from the center coordinate, the angles between \hat{r}_{double} and z(x) will be π. On the other hand, if x is located on a line perpendicular to \hat{r}, the angle will be zero. To see that, consider FIG. 10 where ψ denotes the angle between \hat{r}(x) and v(x). From the figure it is obvious that arg(v)=φᵣ+ψ±π/2. This means that

arg(z)=2φᵣ+2ψ±π=2φᵣ+2ψ+π (modulo 2π)

Since arg(\hat{r}_{double})=2φᵣ the absolute value of the difference between the angles modulo 2π is

|φ|=arg(z)−arg(\hat{r}_{double})=2ψ±π (modulo 2π).

Now, with ψ close to zero, as it would be if the line is part of a stellate pattern, the angle difference will be close to π, as proposed above. On the other hand, if the line is perpendicular to r the angle difference φ will be close to zero.

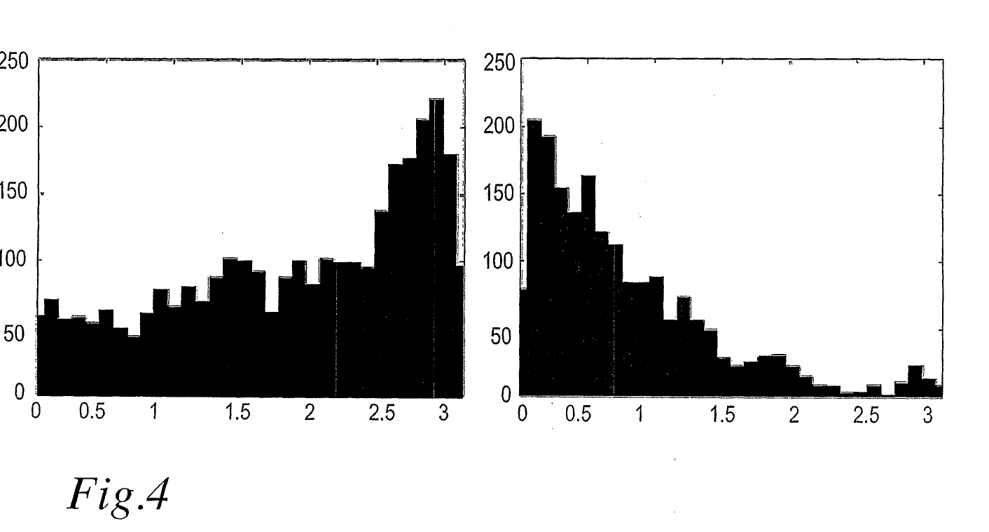

Thus, if the distribution of the angle differences corresponding to the pixels identified in the line image in a local neighborhood is skewed toward π as may be seen in FIG. 4A, this is an indication that many lines are radiating away from the center. If the pixel orientations of the edge image are skewed towards the left in the FIG. 4B, this is an indication that the prominent edges are perpendicular to lines radiating from the center.

The next step in the process is to apply the data to a ROI extractor. Five features are used in the ROI extractor: contrast as discussed above, two fraction of points in the line image in the washer shaped neighborhood that have particular angle deviations, and two features that are similar measures for the edge image.

A support vector machine (SVM) or similar learning machine such as an artificial neural network is used to distinguish between areas that could be potentially malignant and those that could not. This learning machine has been trained using known data prior to using it on unknown data.

Image features (for example the five features mentioned above) are extracted in a number of locations in the image and since the size of possible lesions is unknown three different radii on the washer shaped area are evaluated. The radius where the corresponding features give the highest SVM response is taken as the size of ROI. A typical intermediate result of the ROI is illustrated in FIG. 5, wherein A shows a normal image and B an SVM output from the ROI extraction step.

It should be noted that FIG. 5B do not represent the final classifying decision of the CAD system, but rather the first step of localizing the ROIs that should be further processed. The coordinates with the highest response are then extracted and passed on to the segmentation step.

The coordinates with the highest intensity maxima are extracted as seen in FIG. 5B and a boundary refinement algorithm is initiated around this neighborhood for segmentation. There is several available boundary refinement algorithms may be used in this step. One illustration of the output of such an algorithm may be seen in FIG. 6B using a level set segmentation boundary refinement algorithm, FIG. 6A displays the original digital medical image.

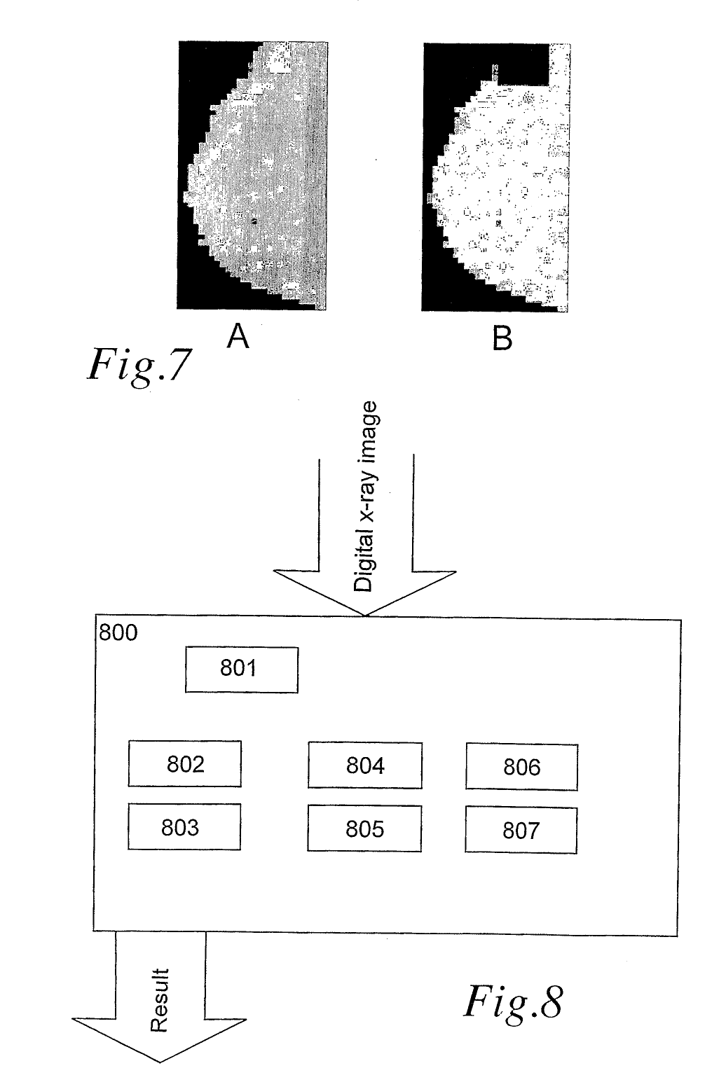

Once the ROI has been segmented from the background, its immediate background is determined as all pixels within a distance d from the ROI, where d is chosen such that the area of background roughly corresponds to the area of the ROI and thus an extended ROI has been constructed. Then the extended ROI is removed from the ROI extractor grid output as shown in FIG. 7. FIG. 7A is the SVM output image and 7B represents a segmented SVM image. This process is repeated until a number of regions of interest are passed on to the next steps in the process: feature extraction and classification.

Using the segmented results, the five features are recalculated using the segmented ROI and its immediate surrounding instead of the washer shaped neighborhoods used in the ROI extraction step. Some additional features are added to aid in the classification. The standard deviation of the interior of the ROI normalized with the square root of the intensity yields a texture measure capturing the homogeneity of the area. An equivalent feature is extracted for the immediate background. The compactness of the segmented ROI is also extracted and these features are then passed on to a classifying machine. The same learning machine implementation as mentioned above is trained with the features from these refined areas.

The final step involves marking the image at found suspicious areas and points for final examination of a radiologist or physician.

The method described above may be implemented in a dedicated external device or apparatus, or incorporated in a mammogram system.

It may also be implemented on a computer medium as a stand-alone system implemental in any computational device with sufficient computing power. Thus, the entire method or parts of the same can be provided as instruction set (computer program).

An exemplary arrangement 800 for processing the image according to the invention is illustrated schematically in FIG. 8. The arrangement, as mentioned earlier can be implemented as a computer unit or in a computer unit, comprising process units. Thus, the arrangement comprises a processing unit 801 (such as a microprocessor of a computer), a module 802 for obtaining image masks, a sampling module 803, a calculating module 804, filtration module 805, classification machine 806 and a support vector machine and/or artificial neural network 807. As it is appreciated by a skilled person, one or several modules can be integrated together and/or in the processor unit or run as instruction sets. Other units such as memories, interfaces etc. included for proper function of the computer unit are not illustrated.

It is appreciated that, the invention is not limited for signal processing of image data from generated in an x-ray apparatus. It is likewise possible to process any image data seeking to find image information as described earlier.

It should be understood that the above-mentioned embodiment is only discussed for illustrative purposes and does not limit the invention. Numerous modifications and variations of the present invention are possible in light of the above teachings without departing from the spirit and scope of the invention as limited only by the following claims.

1. A method of detecting a Region of Interest in an image data set, especially digitalized X-ray image, the method comprising the steps of:
a. extracting phase information from the image data,
b. using said phase information for differentiating between different lines and edges, and
c. skewing said lines towards a centre.

2. The method of claim 1, wherein said step a. comprises extracting an orientation estimate.

3. The method of claim 1, wherein said step b. comprises additional information on a magnitude from a filter answer.

4. The method of claim 1, wherein said region of interest is stellate lesions and said image data is a digitalized mammogram.

5. The method of claim 4 comprising the alternative steps of:
a. obtaining an image data corresponding to said mammogram (901);
b. obtaining an image mask (902);
c. substantially uniformly sampling (903) the digital image inside said mask and producing sample points;
d. calculating (904) for each sample point a characteristic;
e. selecting (905) a number of sampling points most likely to correspond to a spiculated lesion;
f. applying (906) a segmentation procedure to the original digital image at said selected sampling points;
g. extracting (907) new characteristics from each segmented area and obtaining a feature vector;
h. classifying (908) each feature vector as suspicious or non-suspicious using a classification machine; and
i. examining (909) said suspicious areas.

6. The method of claim 5 wherein said characteristics in said step d comprises one or several of:
contrast,
two measures of spiculatedness, and
two measures of edge orientations.

7. The method of claim 6 wherein said contrast, is derived as a ratio between an intensity inside a circle with a radius r1 and a washer shaped background area with inner radius r1 and an outer radius r2.

8. The method of claim 6 wherein said two measures of spiculatedness are derived from a histogram of angle differences obtained using a filtration method that yields phase information together with orientation estimates.

9. The method of claim 6, wherein said two measures of edge orientations are derived from a histogram of angle differences obtained using a filtration method that yields phase information together with orientation estimates.

10. The method of claim 5, wherein said step e is provided using a support vector machine or an artificial neural network.

11. The method of claim 6, wherein said classification of each feature vector is provided using a classification machine.

12. The method according to any of claims 5-10, wherein the entire image is sampled.

13. The method of claim 5, wherein each node in the applied sampling grid is evaluated in terms of contrast and spiculation.

14. An arrangement (800) for detecting a Region of Interest in an image data set, especially digitalized X-ray image, which arrangement extracts phase information from said image, uses said phase information for differentiating between different lines and edges, and skews said lines towards a centre, the arrangement comprising: a processing unit (801), a module (802) for obtaining image masks, a sampling module (803), a calculating module (804), filtration module (805), a classification module (806) and a support vector machine and/or artificial neural network module (807).

15. The arrangement of claim 14, wherein said filtration module is a set of quadrature-filter.

16. An x-ray apparatus comprising an arrangement according to any of claims 12-13.

17. A computer unit comprising a processing unit, a memory unit, storage unit, said computer unit being operatively arranged with an instruction set to acquire an image data set, especially digitalized x-ray image, said instruction set having procedures for: detecting a Region of Interest in a said image data, extracting phase information from said image, obtaining image masks, sampling, calculating, filtration, a classification and supporting vector and/or artificial neural network.
